(19) United States
(12) Patent Application Publication
(10) Pub. No.: US 2016/0057994 A1
(43) Pub. Date: Mar. 3, 2016

(54) Aplatelet Clays for Sustained Release of Active Ingredients

(71) Applicant: BioGuard Research and Development, Inc., Kennewick, WA (US)

(72) Inventors: Edward S. Lipinsky, Fairview, NC (US); Dominic A. Cataldo, Kennewick, WA (US); Peter Van Voris, Daniel Island, SC (US)

(73) Assignee: BioGuard Research and Development, Inc., Kennewick, WA (US)

(21) Appl. No.: 14/093,548

(22) Filed: Dec. 2, 2013

(51) Int. Cl. A01N 25/08

(52) U.S. Cl. CPC A01N 25/08

(57) ABSTRACT

A method of forming an active control ingredient that controls target living species over an extended period of time commences by providing a clay material that has a structure substantially depleted of platelets (“aplatelet”). The aplatelet clay material is heated with a solid active control agent to a temperature of at least about 10° C. above the melting point of the solid active control agent. The aplatelet clay material then is loaded with the heated solid active control agent.

### CROSS-REFERENCE TO RELATED APPLICATIONS

None.

### STATEMENT REGARDING FEDERALLY SPONSORED RESEARCH

Not applicable.

### BACKGROUND

Disclosed are formulations that release pesticides, repellents, and attractants for insects and other animals, fungicides, herbicides, repellents for plant roots, and like active ingredients (control agents) and more particularly to the use of materials that contain aluminum and/or silica for sustained and controlled release of such active ingredients. Ordinary clays have platelets. The present disclosure concerns only materials that have no platelets or “aplatelet” materials, the “a” indicating the absence or lack of, in this case, “platelets”. Their reservoir method involves pores and surface area.

### Herbicides and the Like

Roots from trees and shrubs are known to cause a variety of problems as well as damage to man-made infrastructure. For example, sanitary and storm drain systems in cities and other municipalities are aging with part of the problem induced by the roots of trees. The aging process involves physical cracks and joint dislocations, resulting in leakage of sewage and storm waters to soils, ground waters, and surface waters. A number of remedial relining methods are available. These work for a short period and are then degraded by plant roots seeking out moisture and nutrients, entering the lines, dislocating and degrading the linings, and thus creating the original problem. To counter this problem of plant-root intrusion, options have been used whereby liquid herbicide is simply flushed through the sewer lines or the sewer line is wrapped with a herbicide releasing fabric; however, the later needs to be done when the sewer line has been dug up for repairs or when new sewer lines are being laid.

New products and methods are needed to control the intrusion of roots not only into sewer and other pipes, but also into sidewalks, golf course areas, especially greens. The new methods and products also could be used to control weed growth in landscaping, plant nursery, and agricultural situations.

For piping systems, these methods and products should offer reduced transport of herbicide into the environment and reduced disturbance of the piping system. For sidewalks, golf courses, landscapes, etc., application of the product should disrupt the system rarely.

Noxious weeds, including, for example, several species of knapweed and leafy spurge, continue to plague farmers, ranchers, and wildlife in the western United States. An improved weed control system is needed that will provide long term control while reducing pollution and environmental damage. Recent advances in pesticide formulations may offer a solution to this problem. A sustained release delivery system capable of delivering small but continual doses of herbicide to the weeds may provide the long term control that farmers and natural resource managers need. Sustained release formulations can deliver the most effective chemical concentration while not saturating the environment or expose humans and wildlife to high concentrations of chemicals. These specialized formulations can deliver a smaller total quantity of chemicals than the traditional broadcast and spraying methods used to apply commercial herbicides resulting in safer and more effective control of noxious weeds for farmers, ranchers, and natural resources managers.

### Insecticides, Repellents, and Attractants

Wood and wood products utilized in a variety of construction applications are frequently structurally degraded by the action of termites, ants, other boring insects, and wood decaying microorganisms. Typically, these wood degrading and decaying organisms migrate to wood structures via the surrounding soil or water. This migration may occur whether the structures rest upon concrete foundations, such as in wooden building construction; are in direct contact with the soil, for example fence posts, utility poles, railroad cross-ties, wooden supports, and like structures; or are in the water, such as boats, piers, pier pilings, wooden docks, or other supports. Wood and wood-containing products include, inter alia, glued wood products such as, for example, plywood, particleboard, oriented strand board (OSB), medium density fiberboard (MDF), laminated veneer lumber (LVL), laminated beams, and a variety of other engineered wood products. Paper products (especially paperboard and Kraft paper) also are subject to degradation by organisms that attack wood. Outdoor furniture also is subject to wood degrading and decaying organisms. In the marine context (including for example, pleasure and commercial craft for use on lakes, rivers, and oceans), the structures additionally may be manufactured from fiberglass, various plastics, metals, ceramics, and other materials.

Present methods of preventing or retarding the advance of these wood degrading organisms include soil treatment with pesticides and repellent chemicals, treatment of the wood with chemicals, and fumigation wherein the entire structure may be sealed and a pesticide pest repellent released. Both soil and fumigation type treatments may release the pesticide to the surrounding atmosphere and/or the pesticide may move to ground water where it may harm human beings or other living organisms. Disadvantages of these methods of treating soil and/or fumigating include, inter alia, potential ecological and human health concerns, as well as the limited time until the fumigant or soil concentration is sufficiently reduced in concentration to permit ingress of wood degrading organisms.

Although many pesticides and repellents are known to be effective against the action of wood destroying organisms, their effectiveness often declines over time as they are dissipated into the surrounding environment (soil, water, or atmosphere) or are degraded, for example, chemically or biologically. To retain their effectiveness, these insecticides must be repeatedly applied at regular intervals ranging from every few days to every few months to every few years. Alternatively, if the pesticides and repellents are applied in sufficient quantity to be effective over an extended period of time, the ecological and human health related concerns associated with these chemicals and their unpleasant odors are exacerbated. Furthermore, with the banning of certain chemicals and the introduction of safer shorter half-life compounds, even large amounts of many of these pesticides and repellents may be required over a relatively short time periods, and they will need to be reapplied more often.

A further disadvantage of conventional application methods is that the concentration of pesticides and repellents resulting from a single application starts out well above the minimum concentration necessary for effectiveness, but decreases rapidly. Within a relatively short period of time the concentration drops below the minimal effective level necessary to maintain a barrier to the invasion of wood compromising organisms.

An important strategy in control of insects and unwanted animals is the use of attractants. Volatile bait can be employed to bring the target animal to a device that kills it. This method is especially useful for flying insects. The bait method also can be used to measure the identity of species that are in a vulnerable area and to quantify the intensity of an insect infestation

### General

Though prevention of unwanted plant growth and unwanted animals would seem to be unrelated, both areas have certain common goals. One such goal is to be able to release the active ingredient at a desired location at a desired target and at a lower, yet effective concentration. Another goal is to release the active ingredient at a desired or target concentration. A further goal is to release the active ingredient over an extended period of time. Yet another goal is to reduce the cost of effective active ingredients. The disclosure addresses each of these goals by providing a mechanism whereby sufficient active ingredient is stored within pellets for release of a target concentration of active ingredient over an extended periods of time ranging from days to weeks to years and even up to several decades.

### BRIEF SUMMARY

One aspect of the disclosure is a method of controlling target living species with an active ingredient (or control agent) over an extended period of time. In this method, an active ingredient is sorbed into/onto aplatelet clay. An aplatelet clay is defined as a structure that lacks platelets and is made from mineral raw materials. Smectite and vermiculate minerals, for example, have platelet structures that operate by intercalation and exfoliation. Aplatelet clay develops pores for storage and adsorption/absorption of enlarged surface area. It is a manufactured product. Examples include, for example, coal-ash that is treated at 1000° C. to make a porous material and conversion of alumina that is treated at 400° C. to make tenacious surfaces. The resulting product may be used as-is to control the target living species.

Next, a polymer pellet is loaded with the active ingredient loaded aplatelet clay. The resulting product may be used as-is to control the target living species. Finally, the loaded polymer pellet can be formed into a device that is adapted to be placed at a location for controlling a target living species. The formed device contains polymer pellets loaded with aplatelet clay sorbed with an active ingredient that controls the target living species. The sorbed aplatelet clay-loaded polymer pellets are recalcitrant to release of the active ingredient.

In another aspect, Alumina is heated to 400° C. to convert it to an aplatelet clay. It has numerous pores to hold hydrophobic active ingredients tightly.

In another aspect, Brockmann #1 grade of activated alumina is a reservoir for hydrophobic active ingredients. The release rate is monitored and adjusted as needed.

In another aspect, iron slag is heated to the melting point and converted to thin mineral fiber. The cooled porous could be a reservoir for hydrophobic active ingredients.

The active control ingredient will be “liquefied” for its sorbing by the aplatelet clay. By “liquefied” or “fluid” or “fluent” is meant that the (normally) solid active control ingredient will be heated to be fluent, or a vapor, so that in the liquefied state, the aplatelet clay will adsorb the control agent. Such heating will be to a temperature of at least about 10° C. above the melting point of the solid active control agent on up to about 30° C. above the melting point of the solid active control agent. By “solid active control agent”, we mean that the active control agent is a solid at room temperature. At lower temperatures, the active control agent tends to not be absorbed by the aplatelet clay and/or deposits on the outer surface of the aplatelet clay, thus clogging the porosity of the aplatelet clay and preventing further absorption of the active control agent by the aplatelet clay. The addition of an active control agent dissolved in a solvent (even at saturation), has a similar effect.

For these same reasons, the aplatelet clay also should be heated prior to its being contacted by the heated active control agent. It is best if the aplatelet clay is heated to at least same temperature, as is the active control agent to maximize absorption of the heated active control agent by the aplatelet clay, and aplatelet clay can be heated to a temperature of at least about 15° C. above the melting point of the solid active control agent.

In practice, it is advantageous to heat the aplatelet clay or other absorbing carrier as high as feasible without thermally decomposing and/or loosing too much due to the active control agent vapor pressure. With small 10-20 gm samples, one can do the mixing quickly and uniformly at the lower temps. With 0.1 kg and above batches, the clay is normally heated to >15° C. above the melting point of the active control agent, and the active control agent can be amended at some temperature above its melting point (>1°-2° C.), but in practice >5°-10° C. can be used, which allows slow mixing and adsorption, without too much surface crystallization and agglomeration of clay/absorbent particles. This all becomes evident when you can load to >30% (w/w) without the clay carrier clumping (remains friable).

In practice, heating above the melting point, 0° C. or so, actually allows the vapor to penetrate deeper into pores and also allows for condensation, and crystallization within the pores with slow cooling down to ambient. This leads to a maximum active loading without sorbent surface crystallization of active material, which tends to agglomerate the carrier, rather than keeping it friable.

“Recalcitrant” to release of the active ingredient means that the loaded polymer pellets retard the release of the active ingredient to provide a sustained release over time. Appropriate times can be years to decades for some target species and days to months for other target species. The inventive sorbed aplatelet clay loaded polymer pellets can be designed or tailored to meet the demand requirements of a variety of pests.

Polymer “pellets” means particulates, discrete or agglomerated, regardless of shape—smooth, rough, jagged, or the like. Pellets, then, can be described as, for example, beads, particles, grains, crumbs, bits, or the like. Again, shape is unimportant with size determined by intended use in terms of environment, target species, type of control agent, type of barrier, and like factors.

“Target living species” or “target species” means any living organism including, inter alia, plants, animals, fungi, bacteria, viruses, insects, fish, mollusks, and the like. Target species can be found anywhere, including, inter alia, in the air, under the ground, on the ground, in water, in/on structures (both living and inanimate), or anywhere else.

“Control agent” or “active ingredient” means a chemical and/or biological agent that has the function of controlling a target species. In turn, “control” means to repel, attract, kill, or exert a desired action on a target species.

Disclosed, then, is method of forming an active control ingredient that controls target living species over an extended period of time commences by providing a clay material that has a structure substantially depleted of platelets (“aplatelet”). The aplatelet clay material is heated with a solid active control agent to a temperature of at least about 10° C. above the melting point of the solid active control agent. The aplatelet clay material then is loaded with the heated solid active control agent.

### DETAILED DESCRIPTION

The control products or devices of this disclosure can take the form of a barrier to prevent infestation of a specific location or an attractor that lures the target species to a specific location or a signal that affects the behavior of the target living species.

Each device or barrier (these terms being used interchangeably to denote a physical structure that containing the loaded nanoclay for slow release of the loaded active control agent) can operate in one, two, or three dimensions. Examples of one-dimensional devices are filaments, strings, and cords. Examples of two-dimensional devices are coatings, films, sheets, and fabrics. Examples of three-dimensional devices are slabs, spray drops, and laminations. The device may be a continuous solid object or a discontinuous pattern of active ingredient loaded aplatelet clay or polymer pellets.

As stated above, the disclosure enables the artisan to place a barrier or other device at desired location for controlling unwanted pests for times ranging from days to months for certain target pests on up to years, e.g., 1 year, 10 years, 20 years, 30 years, or more, for other target pests. The barrier can be a fabric or other material loaded with the polymer pellets, a dispersal or pattern of the polymer pellets at the site; a coating, adhesive, caulk, sealant, or other material loaded with the polymer pellets, or the like. The precise form of the barrier is not the focus of the present disclosure, as a variety of barriers are known in the art. Lacking in the art is a method for providing sustained release of a control agent. By loading polymer pellets with colloidal clay loaded with the active ingredient or control agent, which sorbed aplatelet clay-loaded polymer pellets are recalcitrant or retardant to release of the control agent and by judicious formulation of the barrier, effective sustained release of a control agent can be achieved for control of a target pest.

Insofar as the control agent or active ingredient is concerned, the aplatelet clay and polymer pellets do not distinguish between insecticides, insect repellents, attractants (e.g., sex pheromone and/or pheromone-like attractants), herbicides, fungicides, or the like, and mixtures thereof. Thus, the inventive system has broad applicability to a variety of pests. The same is true of the environment in which the pests can be found. That is, design of the polymer pellet and barrier design permits the sorbed aplatelet clay-loaded polymer pellets to be used in desert environments, marine environments, home environments in virtually any climate, industrial and commercial environments, etc.

The aplatelet clay yields best performance in longevity and reduced control agent degradation, compared with conventional clay, carbon black, and other fillers proposed in the prior art. The Examples will detail such performance.

The sorption process can use pest control agent (e.g., diethyl adipate) vapor that contacts and permeates into the tiny clay particles. A fluidized bed process is especially convenient for loading the particles with volatile pest control agents. Molten pest control agent (e.g., Trifluralin) can be used for loading less volatile pest control agents.

The loaded aplatelet clay is incorporated into a polymeric (e.g., elastomer) matrix that is advantageously is a polyurethane polymer. Other polymeric materials include, inter alia, polyethylene, polypropylene, polybutenes, natural rubber, polyisoprene, polyesters, styrene butadiene rubber, EPDM, polyacrylates, polymethacrylates, polyethylene terephthalate, polypropylene terephthalate, nylon 6, nylon 66, polylactic acid, polyhydroxy butyrate, polycarbonate, epoxy resins, or unsaturated polyester resins.

The pellet content of the system must contain enough active ingredient to release at a rate that is adequate to repel the target pest species for a period of time that meets the longevity goals. For example, if the release rate is one microgram/cm²/day for 30 years (ca. 11,000 days), then the pellets must store at least 11 mg for each square centimeter of surface area. The concentration of active ingredient in the bead additionally must not exceed a threshold level that would cause barrier failure.

Acceptable insecticides include those insecticides approved by the U.S. Environmental Protection Agency to kill or repel termites, ants, other boring insects, and wood decaying microorganisms. The class of insecticide which is presently preferred for use in the present disclosure are pyrethrins, including tefluthrin, bifenthrin, lambdacyhalothrin, cyfluthrin, deltamethrin, cypermethrin, permethrin, and natural permethrin. It will, however, be recognized by those skilled in the art that other effective insecticides such as isofenphos, fenvalerate, cypermethrin, organophosphate type insecticides, repellents as well as naturally occurring chemicals that act as irritants such as skunk oils and extracts of pepper can also be used. These insecticides are available from a number of commercial sources such as, for example, Dow Chemical Company, Bayer, ICI Industries, Velsicol, Novartus, Syngenta, and FMC Corporation.

Insecticides, pesticides, pest species repellents, alone or in combination with one and another, or in combination with other bioactive ingredients, such as fungicides, may also be used in accordance with the present disclosure. Combinations of insecticides, pesticides, repellents, nematicides (also referred to as nematocides), and fungicides additionally may be used to advantage. Fungicides include, for example, carboximide, dicarboximide, diflumetorim, ferimzone, chloropicrin, pentrachlorophenol, tri-chloronitromethane, 1-3 dichloropropane, and sodium N-methyl dithiocarbomate. Nematicides include 1,3 dichloropropene, ethoprophos, fenamiphos, benfuracarb, and cadusafos.

Commercial mollusicides include, inter alia: Niclosamide (Bayluscide) from Bayer; Clamtrol from Betz; Calgon H-130 from Calgon, and Mexel 432 from RTK Technologies. These products are intended for controlling Zebra Mussels that cause water intake problems for electric power plants and/or the snails that carry Schistosomiasis. Copper compounds, e.g., cuprous oxide, have been a favorite leachable component of antifouling paints. Insoluble cuprous chelates could be active ingredients that bloom to the surface and stay there repelling fouling organisms. Commercial antifouling paints (e.g., SIL MAR) that feature silicone ingredients make the surface too slippery for fouling fauna to form a stable attachment. Organotin compounds are known to work, but their use has been banned. Copper compounds are seen to present toxicity issues too. Organic antifouling agents, such as are disclosed in U.S. Pat. No. 5,441,743, may be used to advantage too. Endod, a natural plant extract from the soapberry bush, contains saponin and lemmatoxin. Endod has been used to control Zebra and Quagga Mussel infestations.

### Herbicide Embodiment

The root intrusion problems that affect sewer systems, sidewalks, golf courses, etc., can be treated effectively with herbicides. However, conventional sewer treatment only lasts for a few days or weeks. Most conventional systems for delivery of Trifluralin for appreciable lengths of time generate environmental burdens in the form of contamination of ground water. The few exceptions (e.g., BioBarrier I and II) are not suitable for application to pipes and other substrates of this disclosure; although, other systems can be adapted for use on irrigation and other piping.

Sustained release systems are needed, which systems keep the roots away for years. Trifluralin is an outstanding herbicide for these uses, but the suggested embodiments could be applied to other 2,6-dinitroaniline herbicides and many other types of herbicides. In this patent application, the term “TRIFLURALIN” includes other 2,6-dinitroaniline herbicides and other root-growth repellent herbicides.

While the disclosure has been described with reference to a preferred embodiment, those skilled in the art will understand that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

### EXAMPLES

Various clay carriers were evaluated to determine their capacity to adsorb and retain pesticide, and their capacity to thereafter release the pesticide. The results recorded would apply to other control agents, e.g., herbicides, insect attractants, etc.

Aplatelet clays are loaded with one or more of the commercially available amine chemicals, as follows:
(a) protonated octadecylamine);
(b) methyl tallow bis(2-hydroxyethyl) ammonium salt;
(c) dimethyl diialkyl [C14-C18] Ammonium salt.

### Typical Mixing Procedure

Trifluralin (Treflan® from Dow Elanco; melting point reported to be 46°-47° C.) is heated to 68°-70° C., at which point it melted. A Blakeslee mixer (Model B-20) is adapted to have its interior heated to the desired temperature. The temperature of the aplatelet clay, also 68°-70° C., and added pesticide within the bowl is maintained using heating straps attached to the outside mixing bowl (heaters controlled at 65° C., actual temp of stirred aplatelet clay pesticide mixture is 50° C.). The aplatelet clay is slowly added to the mixer bowl at a rate of 5 mL/min-10 mL/min, with the mixer at a low (1) blending setting. Addition of the trifluralin is halted when the mixture just started to ball up. Mixing is continued for another hour at a higher mixing setting to break smaller clumps. The mixture then is cooled to room temperature, passed through a #60 sieve (<250 microns); remaining clumps (<10% total weight) is gently ground in a 1-quart Waring blender.

Liquid active ingredients (liquid at room temperature) are treated by the same procedure, except that the materials were not heated and cooled.

These procedures do not use water or organic solvents, as is customary in intercalating and exfoliating clays.

### Holding Capacity

Each tested active agent is slow-blended into the aplatelet clay using a Blakeslee mixer, as described above. Active agents are pre-melted, the clay heated, and the heated ingredients mixed by the same procedure. The sorption method of the present disclosure is applicable to a wide variety of solid and liquid active ingredients that have a variety of volatilities.

### Thermoplastics

Injection molded samples (Table 3) were prepared using a Model 45 MINI-JECTOR (Mini-Jector Machinery Corp., Newbury, Ohio). The mold to be used produces test sheets that were 7.5×5 cm and 1 mm thick. The polyethylene used was powdered Quantum Microthene (XU594, 35 mesh). The polymer was mixed with the aplatelet clay or aplatelet nanoclay to provide a final ratio of 2 parts trifluralin to 20 parts polymer (24 gm load for each injection). For the PE, the injector is set up to melt the mixture at 127° C., with the injection nozzle heated to 138° C. Polypropylene is melted and injected at 163° C.

These sheets were washed in 90% MeOH to remove surface TFN contamination and placed into a flow device that exposes the sample to water that contains 0.01% Tween 20 and 0.5% MeOH. The system is operated at room temperature (ca. 23° C.). These conditions are used as an accelerated test in which 24 hours represents 2-3 years of exposure in the environment. During the first few hours, the release rate is high, usually over 100 μg/cm²/day. The test is continued until the release rate reaches the steady state that is reported in Table 3.

For extrusion and spinning of fibers, the trifluralin-loaded nanoclay is prepared from batches containing 3500 grams of trifluralin and 5476 grams of the nanoclay by the method described in Example 1. The particle size requirement is that the sample pass through a #60 U.S. Sieve (<250 microns). The loading of the trifuralin/nanoclay/polypropylene fiber material in a polyester matrix that is adjusted to provide between 4 and 8% TFN (w/w) for the first fiber run, and 3% TFN (w/w) for the second test run. Pelletized PP material is used for the extrusion and spinning of fibers.

These samples are placed in a flow device that exposed the sample to water that contains 0.01% Tween 20. It is operated at room temperature (ca. 23° C.). These conditions are used as an accelerated test in which 24 hours represents 2 or 3 years of exposure in the environment. This correlation is based on the slope of Arrenhius plots over a temperature range of 10° C. to 50° C. similar systems. During the first few hours, the release rate is high, usually over 100 μg/cm²/day. The test is continued until the release rate reaches the steady state.

### Trifluralin Study

The release rates of aplatelet clay products are compared with aplatelet nanoclay. Comparison of the rates for trifluralin release from polypropylene can be as low as 2% of that of the standard polyethylene. It shows that the choice of matrix polymer can make a significant difference in the relative release rates. The results for melt spinning experiments compare well with those done on molded sheets. These desirable results are due to the combination of the pesticide-loaded aplatelet clay or aplatelet nanoclay and the matrix polymer. As stated above, the increased sorption capacity coupled with slower release rate makes the use of aplatelet clay or aplatelet nanoclay for sustained release pesticide applications unexpected and unique.

### Thermoset Polymers

The following thermosets that contain aplatelet clay or aplatelet octadecylamine nanoclay loaded with a variety of pesticides are evaluated:
(a) Solithane S113, C113 and TIPApolyurethane (Uniroyal).
(b) Flexane 80 polyurea (ITW Devcon).
   The pesticide-loaded aplatelet clay or aplatelet nanoclay are prepared by the method described above.

Solithane S113 is toluene diisocyanate (the isocyanate component) and C1134 is castor oil (the polyol component). The trifluralin-loaded aplatelet clay or aplatelet is dispersed into C113 and then blended with Solithane S113. Tripropanolamine (the catalyst) was added. These ingredients are mixed and cast into a mold that formed sheets similar to the ones used to evaluate the thermoplastics.

Flexane 80 liquid resin is an aliphatic diisocyanate (dicyclohexylmethane-4,4′-diisocyanate). Its curing agent is diethyl toluene diamine. The ratio of resin to curing agent was 78 to 22. The trifluralin-loaded aplatelet clay or aplatelet nanoclay and are blended with the curing agent and mixed with the resin. These ingredients are mixed and cast into a mold that formed sheets similar to the ones used to evaluate the thermoplastics.

The release rates for the urethanes are quite acceptable for most of the intended uses. They are not as low as the release rates from the experiments with thermoplastic polymers; however, both types could be optimized for higher or lower targets to meet target release rates.

Brockmann alumina #1 strongly holds insecticides, even though it does not work via intercalation. If it releases too slowly, it can be partly deactivated by treatment with water prior to exposure to the environment. The degree of deactivation can be controlled by time and temperature of the water treatment. In moist soils and other moist conditions, the water treatment may be part of the controlled release system.

Aluminum oxide is combined with silicon dioxide to yield crystalline aluminum silicate. Aluminum silicates can be converted to amorphous (glassy) products by high temperature treatment. After cooling, laser treatment could be used to make pores in this material. Nanomer chemicals, then, could be used to coat the glassy surface of the pored product.

### Preparation of Aplatelet Nanoclays

Aluminum oxide particles and silica particles are mixed. The mixture is placed in a container that withstands high temperatures. Heat is applied to make the mixture molten (240° C. to over 1,000° C., as needed). The reaction mixture is allowed to cool slowly. The product resembles clays, sometimes including glasses. The product is reduced to a desired particle size (<200 mesh).

The product is treated with one or more of a protonated amino compound: octadecylamine, methyl tallow bis(2-hydroxyethyl) ammonium salt, or dimethyl diialkyl [C14-C18], ammonium salt, or other protonated amine compounds.

Loading of Pesticides into Aplatelet Clay or Aplatelet Nanoclay

The selected pesticide is loaded into the aplatelet nanoclay as follows: The pesticide is heated to its melting point. A Blakeslee mixer (Model B-20) was adapted to have its interior heated to the desired temperature. The temperature of the aplatelet clay or aplatelet nanoclay, is brought to the same temperature, and added to pesticide within the bowl was maintained using heating straps attached to the outside mixing bowl (heaters controlled at 65° C., actual temp of stirred clay pesticide mixture was 50° C.). The aplatelet clay or aplatelet nanoclay is slowly added to the mixer bowl at a rate of 5 mL/min-10 mL/min, with the mixer at a low (1) blending setting. Addition of the pesticide is halted when the mixture just started to ball up. Mixing is continued for another hour at a higher mixing setting to break smaller clumps. The mixture then is cooled to room temperature, passed through a #60 sieve (<250 microns).

Liquid active ingredients (liquid at room temperature) were treated by the same procedure, except that the materials were not heated and cooled.

### Example 1

Activated aluminum oxide is made from alumina or from aluminum trioxide. It is granular and highly porous. It can be made by heating alumina (aluminum oxide) to 400° C. for 16 hours. An alternative method is to heat aluminum trioxide to 500° C. Many pores are in the nano size range (e.g., 5 nm to 7 nm) are produced. The surface area of this product is greatly increased (200 m2/g).

Choice of heating temperature and time, and cooling time and temperature can affect the surface area and sorption behavior of the aplatelet clay. Treatment of aplatelet clay with one or more of: water, methanol, ethanol can be used to optimize the sorption behavior.

This example reveals a steam method to make activated alumina.

The alumina is heated in an electric furnace to reach 200° C. Then, steam is used as the heating method to deactivate the product to the needed degree. Then the electric furnace is used to complete the process.

The literature reveals that desorption of active ingredients from activated alumina is accomplished by elution with solvents. This method is not acceptable for pesticide and many other applications. In dealing with the prior loading methods, it is customary to dissolve the active ingredient and impurities in a solvent. The solution then flows through a column that consists of activated alumina. The flow may be via gravity or now usually pressurized movement (flash chromatography). What is not done is to stir the solution with the activated alumina so that the active ingredient enters the pores and the surface area. The loaded product then is filtered so that the solvent is removed. The solvent that got into the activated alumina is partially removed by use of vacuum and/or heat. The residual solvent helps in the release of the active ingredient. With activated alumina, however, the problem is probably not sorption, it is desorption! Solvent loading has proven unworkable, as when solvents are used they occupy too much of the available space for absorption/fill, which leads to reduced active loading compared to vapor or liquefied loading according to the disclosed process.

According to the present disclosure, the aplatelet clay needs to be gradually degradable so that the active ingredient can be released. The steam treatment may weaken the aplatelet clay sufficiently or the steam vapor can include, for example, an acid vapor such as acetic acid vapor or hydrochloric acid vapor.

### Example 2

A full range of standardized aluminas is available with defined activities, pH values, and particle sizes. Activated aluminas are characterized by their Brockmann Activities Grades of I, II, III, IV, and V. Activated alumina can be made from aluminum trihydrate by heating at 500° C. Alternately, it can be made by treating aluminum oxide at 400° C. followed by cooling gradually for 16 hours. Either process leads to a highly porous material. This material can be used in pellet form or it can be converted to a sol form.

Activated Alumina sols are colloidal hydrous alumina sol particles. They have a strong surface charge (zeta potential). Alumina Sol-100 and -200 are commercially available. Solid particles can be coated with Activated Alumina sols so that slow release can be attained.
1. Weigh a sample of Brockmann grade 1.
2. Weigh a chosen amount of active ingredient.
3. Mix the two so that the active ingredient is sorbed and place in desired environment.
4. Weigh the material at convenient intervals, record the results as graphs or spread sheets.
5. It is likely that Brockmann grade 1 will hold actives too tightly.
6. Reduce tenacity of #1 by shaking a fresh sample with water (or methanol or acetone) to make one or more of grades II, III, IV, or V.
7. Repeat steps 2 through 5 on favorites chosen in step 7.
8. Use graphs and/or spreadsheets to estimate value.

Brockmann alumina is a commercially available activated alumina. These materials are optimized for use in chromatographic analysis. Selected solvent eluents are used to release the captured chemical(s). Release of active ingredients usually will require a different optimization. The choice of type to use depends on the chemical structure of the pesticide and the environment into which the active ingredient is being released.

If the active ingredient can withstand pH 10, Brockmann #1 is potentially useful as is. Conversion may be needed if the active ingredient is sorbed too strongly. This may require water washing of the end product. If this fails, treatment of the Brockmann alumina with, for example, acetone or acetic acid may succeed. Or switching to neutral or acidic activated aluminum oxide may succeed. These approaches seem to reach the limits of the current state of the art.

The disclosed process would use steam at, for example, about 200° C. to about 600° C. to process the alumina so that the pores of the activated alumina are treated as they are formed. The process may include, for example, acetone or methanol vapors to coat the pores with hydrophobic material.

### Example 3

The coat industry has waste products that are called “ashes”, which have ingredients that resemble those of natural clays. The coat industry has developed fly ash into constituents of concrete and road components. Coal ash averages currently about $6/ton, which makes it a good potential raw material for making aplatelet clay.

The disclosure calls for conversion of coal ash into aplatelet clay by the following steps:
1. use an electric furnace to heat fly ash or bottom ash to make it fully molten (about 1,000° C. to 2,000° C.).
2. slowly cool the molten mass to ambient temperature to form an aplatelet clay product. If quenched rapidly, an amorphous material is formed.
3. optionally, convert the molten mass and/or tooled mass to particles of useful size.

1. A method of forming an active control ingredient that controls target living species over an extended period of time, which comprises the steps of:
(a) providing a clay material that has a structure substantially depleted of platelets (“aplatelet”);
(b) heating a solid active control agent to a temperature of at least about 10° C. above the melting point of said solid active control agent; and
(c) loading the aplatelet clay material with said heated solid active control agent.

2. The method of claim 1, additionally comprising the step of:
(b1) treating the aplatelet clay material of step (a) with an ammonium ion chemical having 6 or more carbon atoms prior to the loading step (c).

3. The method of claim 1, wherein said provided aplatelet clay material provided in step (a) contains silica.

4. The method of claim 1, wherein said provided aplatelet clay material provided in step (a) has been treated with a nanomer.

5. The method of claim 1, further comprising:
(d) treating the loaded aplatelet clay in step (c) with a polymer recalcitrant to release of said control ingredient.

6. The method of claim 1, wherein said aplatelet clay material comprises Brockmann alumina #1 whose pH and/or release rate has been adjusted for the solid active control agent, said adjustment optionally including steam treatment.

7. The method of claim 1, wherein said solid active control ingredient is one or more of a chemical agent or a biological agent, which one or more of repels, attracts, kills, or exerts a desired action on said target living species.

8. The method of claim 1, wherein said aplatelet clay material of step (a) is derived from heating alumina or coal-ash or iron slag and cooling slowly.

9. The method of claim 2, wherein said aplatelet clay material is derived from reaction with one or more of protonated amine, octadecylamine), methyl tallow bis(2-hydroxyethyl) ammonium salt, or dimethyl diialkyl [C14-C18] Ammonium salt.

10. The method of claim 9, wherein the ammonium salt is one or more of protonated octadecyl amine, methyl tallow bis(2-hydroxyethyl) ammonium salt, or dimethyl diialkyl [C₁₄-C₁₈] ammonium salt.

11. The method of claim 1, further comprising:
(d) forming said loaded aplatelet clay material into a barrier for control of said target living species.

13. The method of claim 1, wherein the aplatelet clay material provided in step (a) comprises an amorphous glassy material that contains pores made by one or more of laser treatment, thermal treatment, or solvent treatment.

14. The method of claim 1, wherein the aplatelet clay material provided in step (a) was made by steam treatment of alumina heated to between about 200° C. and about 600° C., optionally in the presence of hydrophobic vapors to coat the pores as they form.

15. The method of claim 1, wherein the aplatelet clay material provided in step (a) comprises conversion of coal-ash ash or steel slag into an aplatelet clay material by heating to molten condition and cooling slowly.

16. The method of claim 1, wherein said aplatelet clay material comprises aplatelet nanoclay material.

17. A barrier for control of target living species made by the method of claim 1.

18. A barrier for control of target living species made by the method of claim 2.
